(19) United States
(12) Patent Application Publication
(10) Pub. No.: US 2014/0071118 A1
(43) Pub. Date: Mar. 13, 2014

(54) AUTOSTEREOSCOPIC DISPLAY WITH PRECONVERGENCE

(71) Applicant: Christopher Tyler, San Francisco, CA (US)

(72) Inventor: Christopher Tyler, San Francisco, CA (US)

(73) Assignee: QUALCOMM MEMS TECHNOLOGIES, INC., San Diego, CA (US)

(21) Appl. No.: 13/609,981

(22) Filed: Sep. 11, 2012

(51) Int. Cl. G06T 15/00

(52) U.S. Cl. 345/419

(57) ABSTRACT

This disclosure provides systems, methods and apparatus for use in an autostereoscopic display system. In one aspect, a display device can include a pixel array having a first set of pixels configured to display image data for a viewer's right eye and a second set of pixels configured to display image data for a viewer's left eye. The pixels of the first set can be interspersed amongst the pixels of the second set. A prismatic array can be positioned forward of the pixel array and can have a plurality of prisms coupled to the pixel array. Each prism can be aligned with a pixel from the first set of pixels and a pixel from the second set of pixels. The prisms can be configured to selectively guide light from the pixels to an associated one of the left or right eyes, thereby forming a 3D image.

### TECHNICAL FIELD

This disclosure relates to display devices, and more particularly, to autostereoscopic display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Images generated by a display device (including IMOD-based display devices) are typically two-dimensional and do not naturally have depth. It will be appreciated, however, that the human visual system can provide depth perception by observing a scene, with objects in space, from two slightly different perspectives, one perspective as seen from the left eye, and another perspective as seen from the right eye. The brain then interprets these different views in a combined view to give depth perception for objects in the scene. Thus, it has been found that the perception of depth can be generated by providing slightly different images to the left and right eyes of a viewer, which then “trick” the brain into interpreting the images as forming one view having depth. Displays that produce such images are commonly call three-dimensional (3D) displays. Various systems have been developed to selectively provide different image data to the left or right eyes of viewers. For example, the image for one eye can be displayed with one polarization and superimposed on or interleaved with the image for the other eye, which can be displayed with the opposite polarization. Polarizing glasses can be used to select one image for the left eye and a different image for the right eye, thereby allowing the two eyes to perceive two different images.

The use of viewing glasses, however, can be cumbersome and commercially undesirable. As an alternative, autostereoscopic displays are 3D displays that are able to present different images to each of the left and right eyes without the need for special viewing glasses. Accordingly, the development of 3D display devices is ongoing.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device can include a pixel array. The pixel array can include a first set of pixels configured to display image data for a right eye of a viewer and a second set of pixels configured to display image data for a left eye of the viewer. The pixels of the first set can be interspersed amongst the pixels of the second set. The display device can further include a prismatic array positioned between the pixel array and the viewer and having a plurality of prisms coupled to the pixel array. Each prism can be aligned with a pixel from the first set of pixels and a pixel from the second set of pixels, and each prism can have a first facet and a second facet. The first facet can be configured to be substantially parallel to a line of sight converging towards a region corresponding to a position of the right eye. The second facet can be configured to be substantially parallel to a line of sight converging towards a region corresponding to a position of the left eye.

In some implementations, the apparatus can be configured to substantially converge light rays from pixels of the first set of pixels towards the region corresponding to the position of the right eye, and to substantially converge light rays from pixels of the second set of pixels towards the region corresponding to the position of the left eye. The apparatus can further include a set of dividers, each divider positioned between pixels of the first set and pixels of the second set. The dividers can be configured to substantially prevent light rays intended for the right eye from converging on the left eye and can be configured to substantially prevent light rays intended for the left eye from converging on the right eye. In some implementations, each divider can be associated with a single prism of the prismatic array. Further, the pixel array can be spaced apart from the prismatic array. In some implementations, the dividers can be positioned in the space between the pixel array and the prismatic array.

Another innovative aspect of the subject matter described in this disclosure can be implemented in a method for manufacturing a display device. The method can include providing a pixel array. The pixel array can include a first set of pixels configured to display image data for a right eye of a viewer and a second set of pixels configured to display image data for a left eye of a viewer. The pixels of the first set can be interspersed amongst the pixels of the second set. The method can further include providing a plurality of prisms coupled to the pixel array, with each prism aligned with a pixel from the first set of pixels and a pixel from the second set of pixels. Each prism can have a first facet and a second facet. The first facet can be configured to be substantially parallel to a line of sight converging towards a region corresponding to a position of the right eye, and the second facet can be configured to be substantially parallel to a line of sight converging towards a region corresponding to a position of the left eye.

In some implementations, providing the plurality of prisms can include coupling the plurality of prisms to the pixel array. Further, the plurality of prisms can be configured to substantially converge light rays from pixels of the first set of pixels towards the region corresponding to the position of the right eye, and to substantially converge light rays from pixels of the second set of pixels towards the region corresponding to the position of the left eye. In some implementations, the method can include coupling a divider between pixels of the first set and pixels of the second set. The divider can be configured to substantially prevent light rays intended for the right eye from converging on the left eye and can be configured to substantially prevent light rays intended for the left eye from converging on the right eye. The dividers can be disposed in a space between the pixel array and the prismatic array.

Another innovative aspect of the subject matter described in this disclosure can be implemented in a display device. The display device can include a pixel array. The pixel array can include a first set of pixels configured to display image data for a right eye of a viewer and a second set of pixels configured to display image data for a left eye of the viewer. The pixels of the first set can be interspersed amongst the pixels of the second set. The display device can also include a means for converging light by refraction. The light converging means can be configured to refract light rays from pixels of the first set so that the light rays substantially converge towards a region corresponding to a position of the right eye, and to refract light rays from pixels of the second set so that the light rays substantially converge towards a region corresponding to a position of the left eye.

In some implementations, the display device can include a plurality of dividing means, each dividing means positioned between pixels of the first set and pixels of the second set. The dividing means can be configured to substantially prevent light rays intended for the right eye from converging on the left eye and can be configured to substantially prevent light rays intended for the left eye from converging on the right eye. In some implementations, the dividing means can include a plurality of dividers, each divider associated with a single prism of the prismatic array. Further, the pixel array can be spaced apart from the light converging means. In some implementations, the dividers can be positioned in a space between the pixel array and the prismatic array.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a schematic, isometric view of an autostereoscopic display device.

FIG. 3 is a schematic side view of an autostereoscopic display device having a barrier array coupled to a pixel array.

FIG. 4 is a schematic side view of an autostereoscopic display device having a prismatic array coupled to a pixel array.

FIG. 5A is a magnified, schematic side view of the autostereoscopic display device of FIG. 4.

FIG. 5B is a side view of one implementation of the autostereoscopic display device of FIG. 5A, with dividers positioned between adjacent prisms in the prismatic array.

FIG. 5C is a side view of one implementation of the autostereoscopic display device of FIG. 5A, with dividers positioned between adjacent pixels in the pixel array and in a space between the pixel array and the prismatic array.

FIG. 6 is a flowchart illustrating one method for manufacturing a display device.

FIGS. 7A and 7B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. Further, the disclosed implementations may also be used to improve the quality of 3D autostereoscopic displays in the form of, for example, printed panels, advertising displays, books, greeting cards, postcards, covering material or packaging materials, each of which may be constructed from hard or soft plastics.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, the subject matter disclosed herein can be implemented in an autostereoscopic display device. As explained above, autostereoscopic displays can present independent image data to a viewer's left and right eyes, respectively, so that the viewer can perceive a 3D image instead of a standard two-dimensional (2D) image. For example, a pixel array can include multiple sets of pixels. A first set of pixels can be configured to display image data intended for the right eye of the viewer, and a second set of pixels can be configured to display image data for the left eye of the viewer. As disclosed herein, a prismatic array can be coupled to the pixel array such that light rays emitted from the first set of pixels are configured to converge on the right eye and such that light rays emitted from the second set of pixels are configured to converge on the left eye. The convergence may be caused by refraction of light entering into and/or exiting prisms forming the prismatic array. In some implementations, dividers can be coupled to the pixel array and/or the prismatic array to prevent image data or light rays intended for one eye from propagating to the other, unintended eye.

Particular implementations of the subject matter described in this disclosure can be implemented to realize one or more of the following potential advantages. For example, some autostereoscopic displays are configured such that light rays intended for a particular eye emerge from the display device at substantially similar angles, which may be assumed to provide substantially parallel rays for ease of discussion. In these arrangements, light rays emitted from pixels displaying image data for the right eye can emerge from the display in parallel ray bundles toward the viewer's right eye. Similarly, light rays emitted from pixels displaying image data for the left eye can emerge from the display in parallel ray bundles toward the viewer's left eye. However, because the light rays for each eye propagate parallel to one another, the rays containing image data intended for that particular eye may be configured to converge at a theoretically infinite distance from the display. Consequently, the image received by each eye near the display will only receive a small portion of the corresponding light rays intended to be seen by the respective eyes, and the remaining portion of the display may be misaligned, unclear, or otherwise distorted relative to the information for the other eye. For example, at a given position, only light rays from some of the pixels may reach the viewer's eyes, and the viewer may be able to see 3D depth or stereoscopic information for only a portion of the display, e.g., for only those pixels that have associated light rays that reach the viewer's eye.

Various implementations disclosed herein can pre-converge light rays emitted from a pixel array along two vertical lines representative of the set of positions for the viewer's eyes. For example, a viewer's right eye can be positioned along a first vertical line, and a viewer's left eye can be positioned along a second vertical line spaced apart from the first vertical line by the distance between the two eyes. In some implementations, the display device can converge the light rays on two particular points representing each eye. Thus, instead of directing light rays intended for a particular eye in parallel bundles, the light rays for a particular eye can be directed toward a vertical line along which the intended eye is positioned, such that the light rays from substantially all the pixels of the display intended for the particular eye substantially converge on the associated intended eye. As a result, a viewer may more clearly see an entire image and be provided with the perception of depth across that entire image, avoiding the visual distortion and double images that occur when displays with parallel projection of the light rays are viewed at horizontal angles away from an angle normal to the display surface. In addition, the convergence of light on the viewer's eyes may effectively focus light from the display on those eyes, thereby improving perceived display brightness relative to displays with parallel projection of the light rays normal to the display surface, which are subject to a reduction in brightness as the horizontal viewing angle deviates from the line of sight normal to the display surface.

An additional advantage of the invention is that aligning dividers with the pixels provides for a graceful degradation of the 3D image when the eyes are positioned at points in space away from the location to which the light rays are converged. In other types of displays, e.g., lenticular displays, it is possible to adopt a viewing location such that the each eye receives a mixture of the information intended for both eyes. In these viewing locations, the image information is doubled and unclear, and the depth impression is lost. At other locations, the left eye receives the information intended for the right eye, and vice versa. In these locations, the depth information is reversed, creating an undesirable visual impression of the scene. Aligning the dividers with the pixels prevents the image from being visible when viewed from these locations, avoiding undesirable visual impressions.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

As explained herein, an array of IMODs like those disclosed in FIG. 1 may be implemented in a pixel array for use in an autostereoscopic display. It should be appreciated that any suitable number of IMODs can define a pixel, and that furthermore, any suitable number of pixels and IMODs can be used in the pixel array. The pixel array can be a black-and-white or grayscale display in some implementations. In other implementations, however, the pixel array can include display elements configured to display multiple different colors, such as red, green, and blue to form a multicolor, e.g., RGB (red-green-blue), display device. In some other implementations, the autostereoscopic display can include other types of pixels, such as transmissive pixels (e.g., liquid crystal pixels), other types of reflective pixels, or pixels that generate their own light (e.g., plasma or OLED pixels).

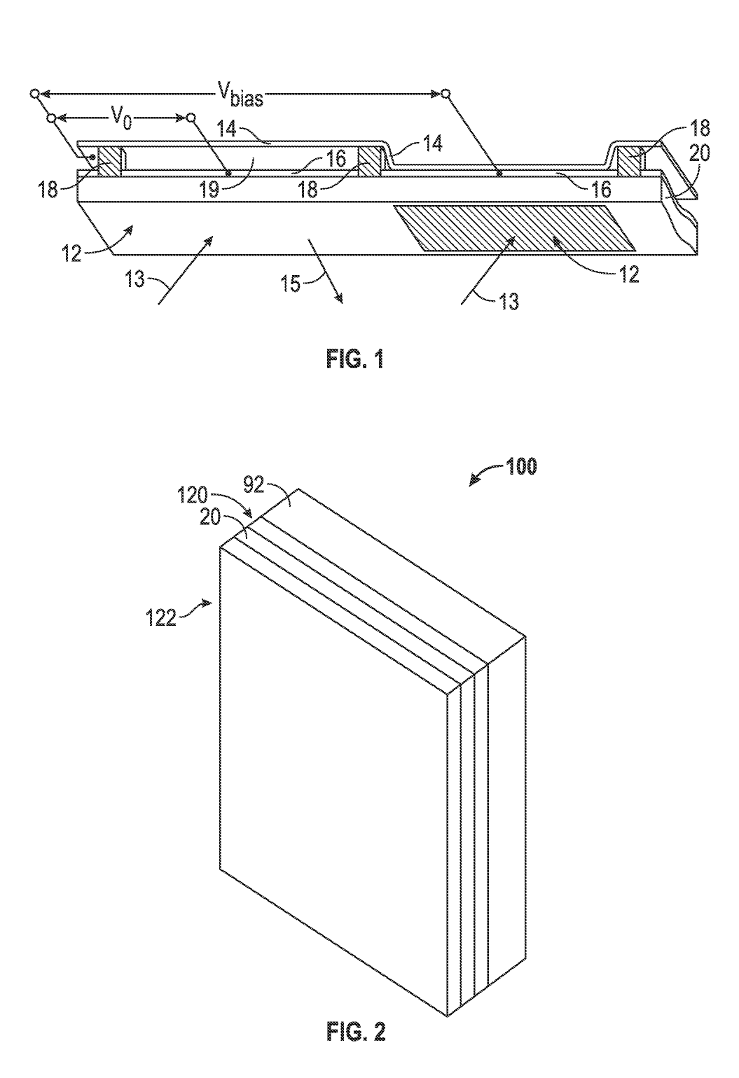

FIG. 2 is a schematic, isometric view of an autostereoscopic display device 100, according to some implementations. The display device 100 can include a pixel array 120 that includes a plurality of pixels. The pixel array 120 can include any suitable number of pixels and can be configured to display any suitable combination of colors, e.g., a RGB color palette in some implementations. In other implementations, the pixel array 120 can be configured to display black and white or grayscale. The pixels can be divided into two sets. A first set of pixels can be configured to display image data for a right eye of a viewer, and a second set of pixels can be configured to display image data for a left eye of the viewer. As explained with respect to FIG. 1, the transparent substrate 20 can be coupled to the pixel array 120 and the pixel array 120 may be formed on the substrate 20, so that the pixel array 120 and substrate 20 form an integral structure. The transparent substrate 20 can be optically transparent to allow light to pass therethrough and can provide structural support for the display elements of the pixel array 120. A backplate 92 may also be formed with or coupled to the pixel array 120. The backplate 92 can support the pixel array 120 on a side of the pixel array 120 opposite the transparent substrate 20. The backplate can include various electrical or electronic components configured to interface with the display elements and/or external systems. In some implementations, the backplate 92 can protect the pixel array 120 from moisture and other contaminants.

With continued reference to FIG. 2, the display device 100 can include a pre-convergence structure 122 coupled to the transparent substrate 20 or to the pixel array 120. In some implementations, the pre-convergence structure 122 is coupled to the pixel array 120 directly. For example, as explained herein, the pre-convergence structure 122 can be a prismatic array in various implementations. The pre-convergence structure 122 can be configured to pre-converge light rays emitted by the pixel array 120 such that light rays containing image data intended for the right eye substantially converge on the right eye of a viewer and such that light rays containing image data intended for the left eye substantially converge on the left eye of the viewer. In implementations utilizing the transparent substrate 20, the emitted or reflected light can pass through the transparent substrate 20. The light can then be refracted by a plurality of prisms in the prismatic array of the pre-convergence structure 122 such that the rays for each eye converge toward the intended eye.

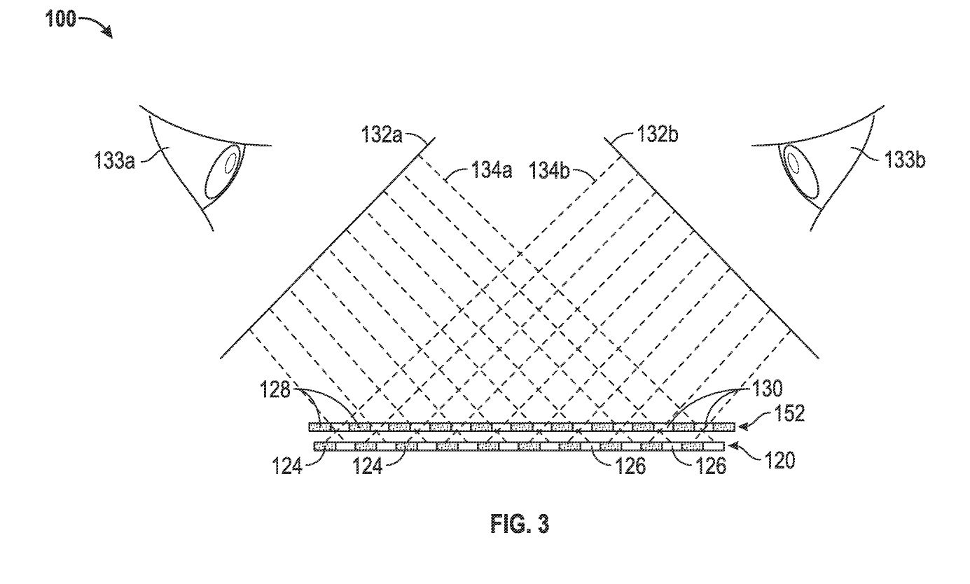

As noted herein, the pre-convergence structure 122 can be a prismatic array. Such an array of prisms can provide advantages over other structures, such as simple barrier arrays, an example of which is shown in FIG. 3. FIG. 3 is a schematic side view of an autostereoscopic display device 100 having a barrier array 152 coupled to a pixel array 120.

The barrier array 152 can include a plurality of barriers 128 alternating with a plurality of apertures 130. As illustrated in FIG. 3, the barriers 128 and the apertures 130 can be sized and positioned relative to the pixel array 120 such that image data displayed on a first set of pixels 126 can propagate along a first set of light rays 134a, and such that image data displayed on a second set of pixels 124 can propagate along a second set of light rays 134b. To achieve stereoscopic or quasi-stereoscopic effects, the apertures 130 can be positioned relative to the pixel array 120 such that light rays 134a intended for the right eye 133a, e.g., the rays 134a emitted or reflected from the first set of pixels 126 are allowed to pass through the apertures 130 toward a right eye image plane 132a. In turn, the barriers 128 are positioned such that light rays 134b intended for the left eye 133b are blocked and do not propagate to the right eye image plane 132a. Similarly, the apertures 130 can be sized and positioned such that light rays 134b intended for the left eye 133b, e.g., the rays 134b emitted or reflected from the second set of pixels 124, are allowed to pass through the apertures 130 toward a left eye image plane 132b. The barriers 128 can also be configured such that light rays 134a intended for the right eye 133a are blocked and do not propagate to the left eye image plane 132b.

While the implementation of FIG. 3 can display stereoscopic or 3D image information, the rays 134a intended for the right eye 133a emerge in a parallel bundle of rays. Similarly, the rays 134b intended for the left eye 133b emerge in a parallel bundle of rays. As explained herein, because the rays intended for a particular eye are mutually parallel, the rays may not converge at the viewer's eye. Indeed, the parallel rays intended for each eye theoretically converge an infinite distance away from the display device 100. This lack of convergence can negatively affect 3D image quality. For example, without being limited by theory, rays 134a and 134b that propagate from pixels 126 and 124 in one region of the display may indeed impinge on or near the intended eye 133a or 133b, respectively. However, other rays 134a and 134b that propagate from pixels 126 and 124 located in another region of the display may not be directed near the intended eye 133a or 133b. Rather, the other rays 134a and 134b in other regions of the display 100 may not be seen by the intended eye 133a or 133b at all, or, alternatively, the sensed image may be greatly distorted due to the lack of convergence. For example, because only a small subset of the light rays impinge on the intended eye, this can potentially cause a decrease in perceived image brightness and/or sharpness in some regions of the display 100.

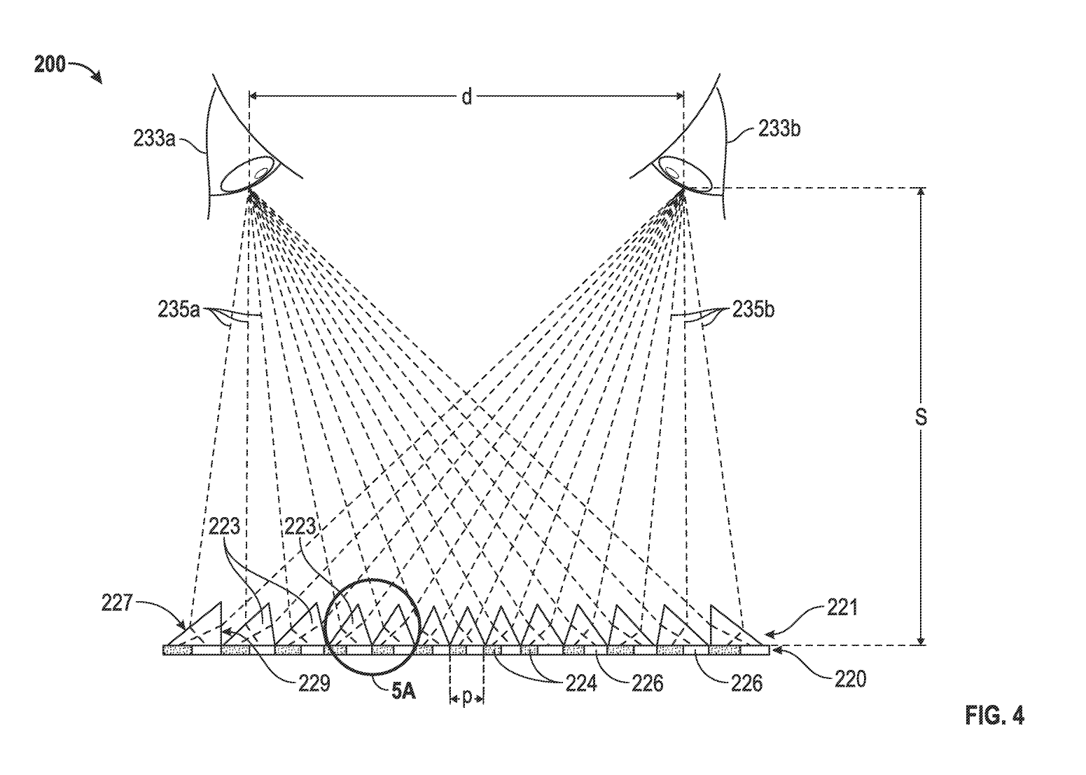

FIG. 4 is a schematic side view of an autostereoscopic display device 200 having a prismatic array 221 coupled to a pixel array 220, according to some implementations. The pixel array 220 can include a first set of pixels 226 configured to display image data intended for a right eye 233a of a viewer. Further, the pixel array 220 can include a second set of pixels 224 configured to display image data intended for a left eye 233b of the viewer. For example, image data displayed by the first set of pixels 226 may include image data captured from a first angle, while image data displayed by the second set of pixels 224 may include image data of the same scene but that is captured from a slightly different, second angle. As explained herein, to achieve 3D or stereoscopic images, the viewer's brain may integrate the data sensed by the right eye 233a and left eye 233b to create depth perception for the displayed image.

As illustrated in FIG. 4, the pixels 226 of the first set may be interspersed amongst the pixels 224 of the second set. For example, along any row in the pixel array 220, each pixel 226 from the first set may be positioned between two pixels 224 from the second set, e.g., along a horizontal direction in FIG. 4. Similarly, each pixel 224 from the second set can be positioned between two pixels 226 of the first set. However, in some implementations, each column or row of the pixel array 220 may include only pixels 226 from the first set or only pixels 224 from the second set. Various other configurations are also possible. Further, as shown in FIG. 4, two adjacent pixels can define a pixel pitch p, which is the combined length of two adjacent pixels 226 and 224. In addition, in various arrangements, the pixel array 220 and the prismatic array 221 can be coupled to or formed with a protective layer (not shown). The protective layer can be optically transparent.

In the implementation of FIG. 4, a viewing distance s may be estimated based on the type or nature of the display device 200. For example, if the display device 200 is part of a mobile device, such as a mobile phone or an electronic reader, then the viewing distance s may be estimated based on the average distance at which a user is expected to position the display device 200 when viewing images on it. For example, for mobile devices, the user may position the display device 200 at about a foot or about 40 cm from the user's eyes, e.g., at arm's length or less (e.g., about 85 cm or less).

In some other implementations, the display device 200 may be part of a television or a monitor, in which case the viewing distance s may vary. Furthermore, the geometry associated with the display device 200 may include an interocular separation distance d, which is the distance separating the right eye 233a from the left eye 233b. Because the interocular separation distance d may not vary significantly across different users, the distance d can be readily estimated. For example, for various users, the interocular separation distance d may be about 6 cm.

For various viewing distances s, pixel pitches p, and interocular separation distances d, the prismatic array 221 can be configured such that light rays 235a intended for the right eye 233a substantially converge on the right eye 233a. Indeed, because the prismatic array 221 can be repeated along a vertical direction (e.g., out of the page in FIG. 4), light rays 235a intended for the right eye 233a can converge along a vertical line. Similarly, the prismatic array 221 can be configured so that light rays 235b intended for the left eye 233b substantially converge on the left eye 233b and, indeed, along a vertical line that includes the left eye 233b. In some arrangements, the light rays can instead converge at a point on or near the intended eye rather than along a line (e.g., a series of points).

In some implementations, the prismatic array 221 can be positioned forward of the pixel array 220 or can be directly attached to the pixel array 220. The prismatic array 221 can include a plurality of prisms 223, each prism 223 having at least a first facet 229 and a second facet 227. As shown in FIG. 4, each prism 223 can be aligned with a pixel 226 from the first set and a pixel 224 from the second set. In some implementations, the prism 223 can substantially span the local pitch p of the pixel array 220. In some implementations, there may be a space between and separating adjacent prisms 223.

The prisms can be formed of optically transmissive material, examples of which can include the following: acrylics, acrylate copolymers, UV-curable resins, polycarbonates, cycloolefin polymers, polymers, organic materials, inorganic materials, silicates, alumina, sapphire, polyethylene terephthalate (PET), polyethylene terephthalate glycol (PET-G), silicon oxynitride, and/or combinations thereof. In some implementations, the optically transmissive material can be a glass. The material (with its associated refractive index) may be chosen in conjunction with the dimensions and angles of the surfaces of the prisms 223 to achieve a desired amount of light refraction to provide convergence, as discussed herein.

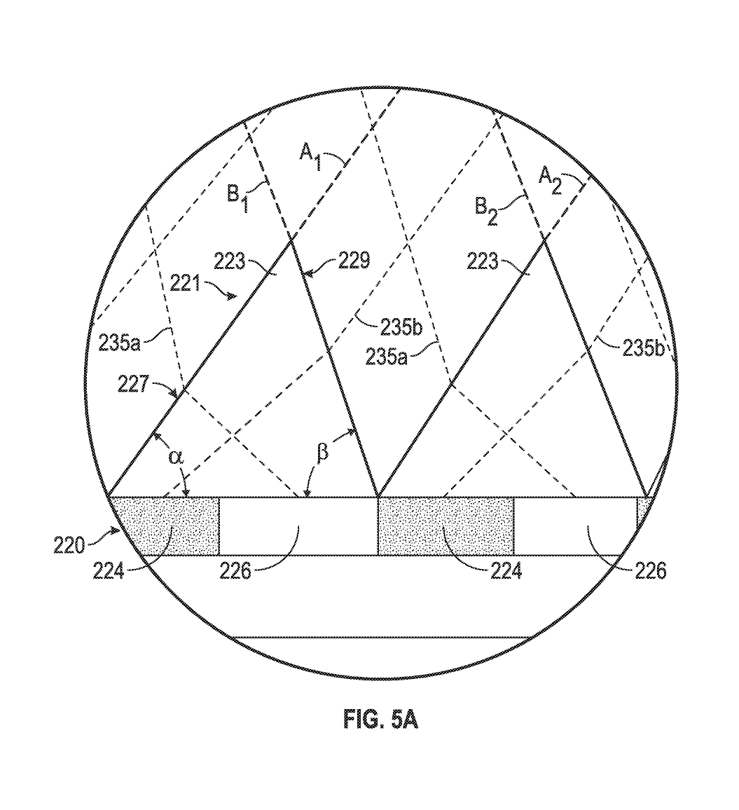

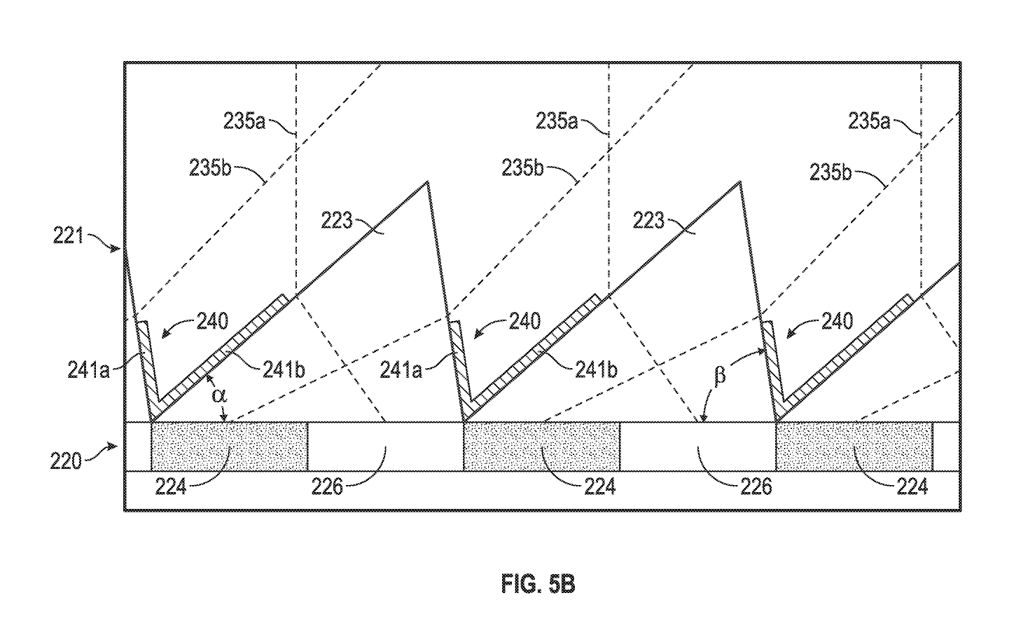

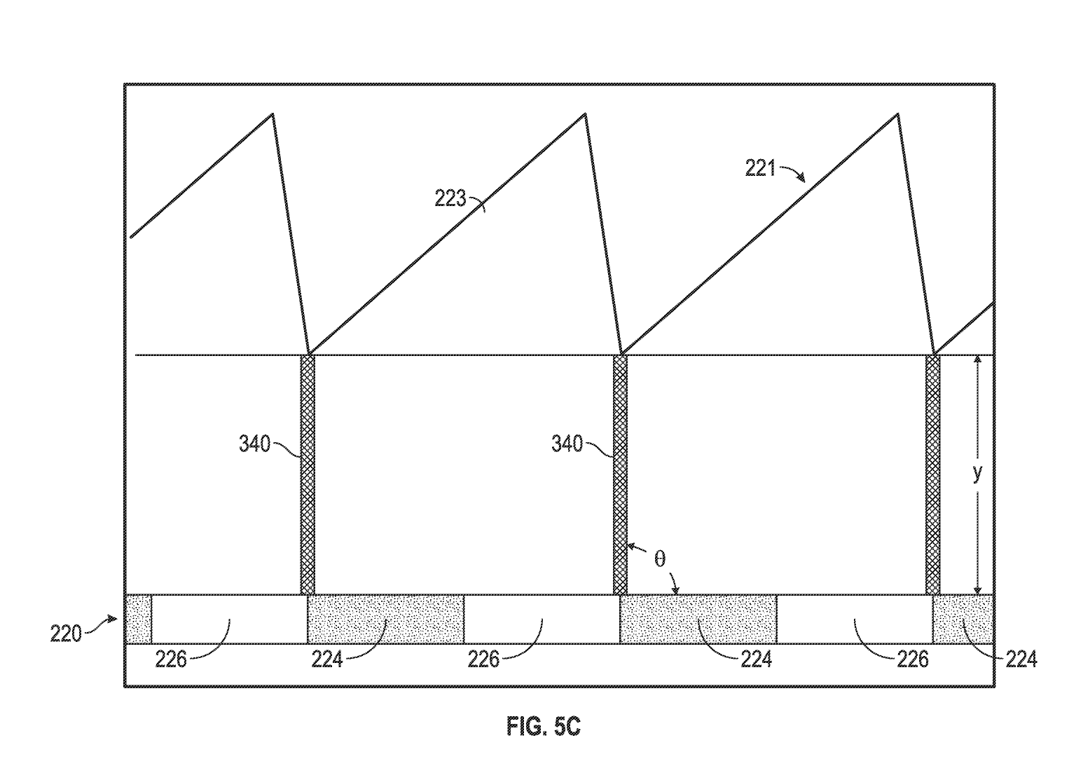

The first facet 229 can be substantially parallel to a line of sight (e.g., a light ray) that converges towards a region corresponding to a position of the right eye 233a. The second facet 227 can be substantially parallel to a line of sight (e.g., a light ray) that converges towards a region corresponding to a position of the left eye 233b. For example, light rays 235a carrying image data intended for the right eye 233a can emerge from the first set of pixels 224 and can converge toward the right eye 233a in a direction substantially parallel to the first facet 229. Light rays 235b carrying image data intended for the left eye 233b can similarly emerge from the second set of pixels 224 and can converge toward the left eye 233b in a direction substantially parallel to the second facet 227. The angles of propagation for light rays 235a and 235b are illustrated in more detail in FIGS. 5A-5B. It will be appreciated that a facet 227 or 229 that is substantially parallel to a line of sight for a particular eye is sufficiently parallel to the line of sight such that light escaping through that facet essentially does not impinge on that particular eye. In some implementations, the facets 227 or 229 are sufficiently parallel to the line of sight of a particular eye, such that less than 10%, less than 2%, less than 1%, or less than 0.1% of the light escaping through that facet reaches that particular eye.

Turning to FIG. 5A but also with continued reference to FIG. 4, a magnified, schematic side view of the autostereoscopic display device 200 of FIG. 4 is shown. As explained herein, the rays 235a intended for the right eye 233a (FIG. 4) can propagate in a direction substantially parallel to the first facet 229, e.g., substantially parallel to the line B₁ and B₂ of FIG. 5A. Similarly, the rays 235b intended for the left eye 233b (FIG. 4) can propagate in a direction parallel to the second facet 227, e.g., parallel to the lines A₁ and A₂ of FIG. 5A. In other words, given an estimated viewer location, in some implementations, the facets 229 and 227 can be angled such that they are each essentially visible to only one eye 233a or 233b. For example, as shown in FIGS. 4 and 5A, the first facet 229 may be essentially visible to only the left eye 233b, such that the right eye 233a essentially cannot see the first facet 229. Similarly, the second facet 227 may be essentially visible to only the right eye 233a such that the left eye 233b essentially cannot see the second facet 227. Without being limited by theory, because the rays 235a emitted from the right eye pixels 226 are substantially parallel to the first facets 229, the left eye 233b cannot see the right eye 233a image data, and vice versa. Consequently, the angled facets 227 and 229 can be angled such that rays 235a carrying right eye 233a image data can converge on or near the right eye 233a and such that rays 235b carrying left eye 233b image data can converge on or near the left eye 233b.

Furthermore, as illustrated in FIG. 5A, the facets 227 and 229 of each prism 223 can be formed at suitable angles α and β with the top surface of the pixel array 220. For example, the first facet 229 can form an angle β with the top surface of the pixel array 220, and the second facet 227 can form an angle α with the top surface of the pixel array 220. The angles α and β can be selected based at least in part on the refractive index of the prisms 223, the interocular separation distance d, the estimated viewing distance s, and the pixel pitch p. The angles α and β can range between about 20 degrees and about 90 degrees in some implementations. Moreover, as explained herein, the index of refraction of the prisms 223 can be used to estimate the ray trajectories as the light rays 235a and 235b pass from the pixels 224 and 226 through the prisms 223 and exit into the surrounding air at the facets 227 and 229. For example, it should be appreciated that the refractive index of the prisms 223 can affect the angles at which light rays emerge from the prismatic array 221 and propagate through the surrounding medium (e.g., air) to the viewer. In some implementations, the prisms 223 can have a refractive index similar to that of glass (e.g., between about 1.3 and 2.4), while the propagation medium, e.g., air, has a refractive index of about 1. Because the index of refraction of the prisms 223 in the array 221 differs from the refractive index of the surrounding medium, the angle of convergence or the propagation angle of the rays may ultimately be associated with the dimensions and angles of the prisms 223 in the array 221. In implementations employing one or more optically transmissive structures (e.g., a protective layer) between the prisms and the medium (e.g., air) to separate the prisms 223 and the viewer, the refractive indices of the optically transmissive structures and medium can be used to estimate ray trajectories as the rays 235a and 235b pass from the prisms 223, through the optically transmissive structure, and into the surrounding medium to the viewer.

Returning to FIG. 4, it should be noted that the angles α and β can vary across various portions of the display device 200. As shown in FIG. 4, for example, α can be smaller at the left edge of the display device 200 and larger near the middle of the display device 200. Similarly, β can be larger near the left edge of the display device 200 and smaller near the middle of the display device 200. It is understood that the variations in α and β in different regions of the display device 200 may result from the different ray trajectories along which each ray 235a and 235b (FIG. 5A) propagates. For example, rays 235a that pass from pixels 226 near the left end regions of the pixel array 220 (as shown relative to the drawings of FIG. 4) may propagate at steeper angles to reach the right eye 233a than rays 235a that propagate from pixels 226 nearer the right end of the array 220.

In addition, in some implementations, to maintain the substantially constant heights for the prisms 223 (such that the tips of the prisms 223 are at a substantially constant distance from pixels of the pixel array 220), the width of each prism may change corresponding to the modifications to α and β. Accordingly, in some implementations, the underlying pixel pitch p may likewise change. As shown in FIG. 4, therefore, the pixel pitch p near the middle of the pixel array 220 may be smaller than the pitch p near the outer ends of the pixel array 220 to accommodate for the narrower prisms 223 near the middle portions of the pixel array 220. Note that the height of each prism 223 in FIG. 4 is substantially the same throughout the prismatic array 221. In other implementations, however, the pixel pitch p may not change with the changing width of the prisms 223. For example, in other implementations, the pixel pitch p and the width of each prism 223 can be selected to be the same throughout the display device 200. To accommodate the different angles α and β, the height of each prism 223 can be modified while keeping the width of the prism 223 constant. For example, the height of the prisms 223 may increase with increasing distance from a midpoint of the prismatic array 221.

FIG. 5B is a side view of one implementation of the autostereoscopic display device 200 of FIG. 5A, with dividers 240 positioned between adjacent prisms 223 in the prismatic array 221. In autostereoscopic display devices, cross-talk between left-eye image data and right-eye image data can disadvantageously reduce 3D image quality. For example, cross-talk can occur when image data intended for the right eye instead impinges on the left eye, and vice versa. Cross-talk can thereby invert the stereoscopic effects of the 3D display, degrading the viewer's depth perception of the 3D image.

In some implementations, a plurality of dividers 240 can be coupled to the prismatic array 221 and/or the pixel array 220. As shown in FIG. 5B, for example, each divider 240 can include a first arm 241a associated with the first facet 229 and a second arm 241b associated with the second facet 227. The dividers 240 can be configured to substantially block light passing through portions of the facets 229 and 227 that underlie the first and second arms 241a and 241b, respectively. For example, the dividers 240 can be formed from any suitable optically opaque material. For example, the dividers 240 may be formed of one or more layers of material (e.g., a metal or opaque dielectric) that is blanket deposited and etched. In addition, as shown, the dividers 240 can occupy a lateral space between adjacent pixels 224 and 226.

In the implementation of FIG. 5B, the first arm 241a of the dividers 240 can be sized and shaped to prevent light rays 235a emitted from the pixels 226 displaying image data intended for the right eye 233a from propagating to the left eye 233b. Likewise, the second arm 241b of the dividers 240 can be sized and shaped to prevent light rays 235b emitted from pixels 224 displaying image data intended for the left eye 233b from propagating to the right eye 233a. In sum, the dividers 240 can be configured to substantially prevent light rays intended for the right eye from propagating to the left eye, and vice versa.

For example, in some arrangements, the first and second arms 241a and 241b can be any length suitable for blocking light rays that may propagate to the inappropriate eye. In various implementations, the first and second arms 241a and 241b can have lengths (and/or areas) that span between about 5% and about 60% of the length (or area) of each associated facet 227 and 229. In other implementations, the first and second arms 241a and 241b can have lengths (or areas) that span between about 10% and about 45%, or between about 15% and 25%, of the length (or area) of each associated facet 227 and/or 229. In some implementations, still other arm lengths may be suitable. In some implementations, as illustrated, the dividers 240 extend upwards form the intersection point of the two neighboring prisms.

FIG. 5C is a side view of one implementation of the autostereoscopic display device of FIG. 5A according to another implementation, with dividers positioned between adjacent pixels in the pixel array and in a space between the pixel array and the prismatic array. As shown in FIG. 5C, the prismatic array 221 may be spaced apart from the pixel array 220 by a distance y. A plurality of dividers 340 may be coupled to the pixel array 220 and the prismatic array 221 such that the dividers 340 are disposed between the pixel array 220 and the prismatic array 221. Further, each divider 340 can separate adjacent pairs of pixels, e.g., pairs that include one pixel 226 displaying image data intended for the left eye and one pixel 224 displaying image data intended for the right eye. The dividers 340 can be formed from one or more suitably opaque material, such as metal or opaque dielectric.

In addition, the dividers 340 may be formed at an angle θ relative to the pixel array 220. As shown in FIG. 5C, for example, the dividers 340 may be formed at approximately a 90° angle with the pixel array 220. In other implementations, however, the angle θ may be different, for example, ranging between about 40° and about 90°. In such implementations, the prismatic array 221 may be horizontally offset (in addition to being vertically offset) from the pixel array 220.

In the implementation of FIG. 5C, light rays for a particular pair of pixels 224 and 226 associated with a single prism 223 may be prevented from crossing the dividers 340 such that image data carried by the rays from that particular pair of pixels is separated from image data carried by the rays from an adjacent pair of pixels formed of one each of the pixels 224 and 226. By separating adjacent pairs of pixels 224 and 226, the dividers 340 of FIG. 5C can allow for the graceful degradation of image quality when the viewer views the displayed image from extreme angles.

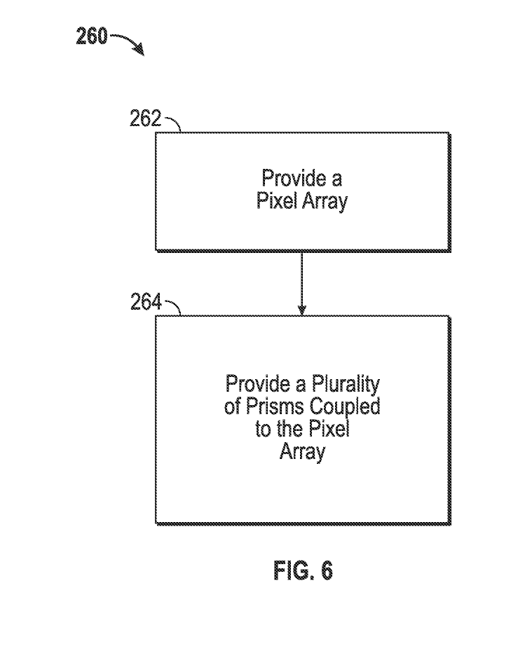

FIG. 6 is a flowchart illustrating one method 260 for manufacturing a display device. In block 262 a pixel array (such as the pixel array 220 of FIG. 4) is provided. The pixel array can include a first set of pixels configured to display image data for a right eye of a viewer and a second set of pixels configured to display image data for a left eye of a viewer. As explained herein, the pixels of the first set can be interspersed amongst the pixels of the second set. For example, as shown in FIGS. 4 and 5A-5B, each pixel of the first set can be adjacent to a pixel of the second set. In some implementations, providing the pixel array can include forming a plurality of interferometric modulators as pixels. It should be appreciated that any suitable number of interferometric modulators can form a pixel. The method moves to block 264 to provide a plurality of prisms coupled to the pixel array. Providing the plurality of prisms can include forming the prisms from an optically transmissive material. Forming prisms can include various processes for giving shape to the optically transmissive material, including, for example, molding or extruding the material, or removing material from a pre-formed sheet of the material (e.g., by cutting or etching). The prisms can be coupled to the pixel array in any suitable manner. For example, as explained with respect to FIG. 2, the prisms can be coupled to a transparent substrate that is coupled to or formed with the pixel array. In some implementations, the array of prisms can be adhered or bonded to the transparent substrate or to another portion of the display that supports the pixel array.

In various implementations, each prism can be aligned with a pixel from the first set of pixels and a pixel from the second set of pixels. As explained herein with respect to FIGS. 4 and 5A-5B, each prism can have a first facet and a second facet. The first facet can be configured to be substantially parallel to a line of sight converging towards a region corresponding to a position of the right eye of a viewer, and the second facet can be configured to be substantially parallel to a line of sight converging towards a region corresponding to a position of the left eye of the viewer. Alternatively, the first facet can be configured to be substantially parallel to a line of sight converging towards the region corresponding to the position of the left eye, and the second facet can be configured to be substantially parallel to a line of sight converging towards the region corresponding to the position of the right eye.

Further, as explained above with respect to FIG. 5B, in some implementations, dividers can be provided on the prismatic array and aligned roughly with the boundary between pixels of the first set and pixels of the second set. The divider can be configured to substantially prevent light rays intended for the right eye from converging on the left eye and can be configured to substantially prevent light rays intended for the left eye from converging on the right eye. In some implementations, the dividers can be coupled to the prismatic array, e.g., by adhering materials or structures forming the dividers directly to the prismatic array. In other implementations, the dividers can be a layer of material that is deposited and patterned on the prismatic array using standard lithographic or other techniques. Furthermore, in yet other implementations, the dividers can be formed on the facets of the prisms by modifying the prisms, for example, by selectively etching or roughening the surface of the prisms to decrease light propagation to a viewer out of certain areas, thereby forming opaque surface areas that constitute dividers. In some implementations, the dividers may be formed on the prismatic array, and the prismatic array, including the dividers, may then be coupled to the pixel array. In other implementations, e.g., as in FIG. 5C, the dividers can be provided between the pixel array and the prismatic array to separate adjacent pairs of pixels.

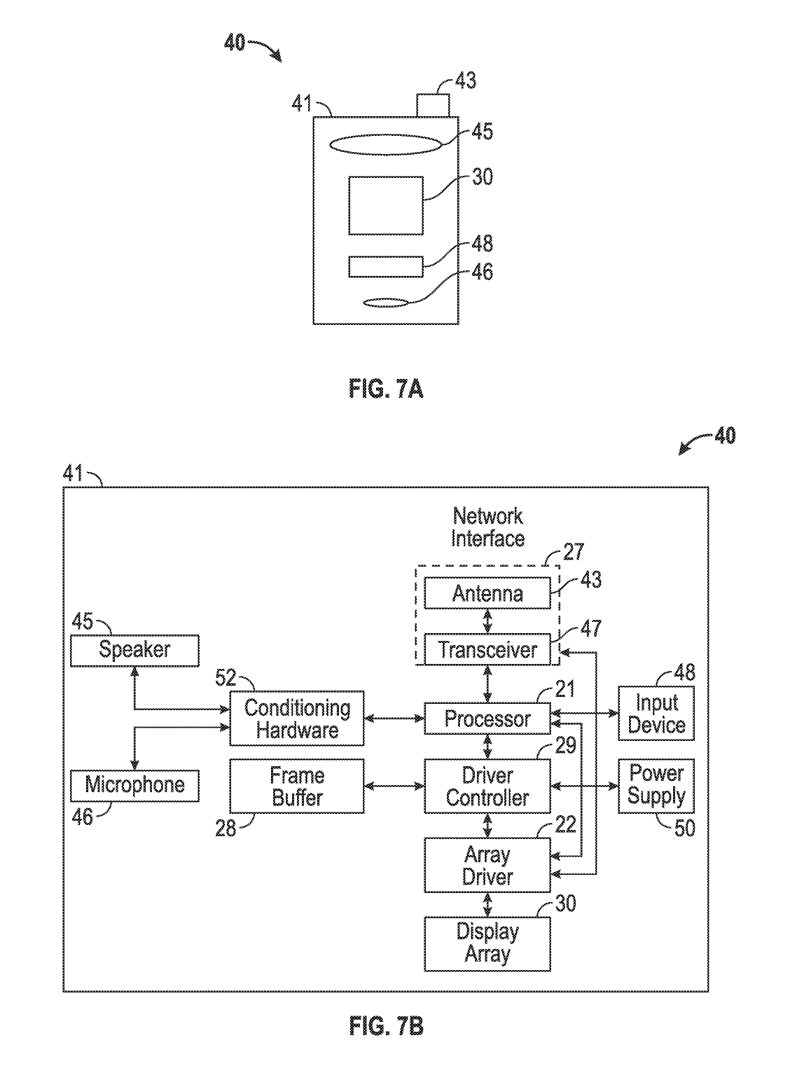

FIGS. 7A and 7B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, handheld devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 7A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 7A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device, comprising:
a pixel array, the pixel array including a first set of pixels configured to display image data for a right eye of a viewer and a second set of pixels configured to display image data for a left eye of the viewer, wherein the pixels of the first set are interspersed amongst the pixels of the second set; and
a prismatic array positioned between the pixel array and the viewer and having a plurality of prisms coupled to the pixel array, wherein each prism is aligned with a pixel from the first set of pixels and a pixel from the second set of pixels, each prism having a first facet and a second facet,
wherein the first facet is configured to be substantially parallel to a line of sight converging towards a region corresponding to a position of the right eye, and wherein the second facet is configured to be substantially parallel to a line of sight converging towards a region corresponding to a position of the left eye.

2. The display device of claim 1, wherein the region corresponding to the position of the left eye is a point corresponding to the position of the left eye, and wherein the region corresponding to the position of the right eye is a point corresponding to the position of the right eye.

3. The display device of claim 1, wherein the prismatic array is configured to substantially converge light rays from pixels of the first set of pixels towards the region corresponding to the position of the right eye.

4. The display device of claim 3, wherein the prismatic array is also configured to substantially converge light rays from pixels of the second set of pixels towards the region corresponding to the position of the left eye.

5. The display device of claim 1, further comprising a set of dividers, each divider positioned between pixels of the first set and pixels of the second set.

6. The display device of claim 5, wherein the dividers are configured to substantially prevent light rays containing image data for the right eye from converging on the left eye and are configured to substantially prevent light rays containing image data for the left eye from converging on the right eye.

7. The display device of claim 5, wherein the pixels are grouped in pairs, each pair including a pixel of the first set and a pixel of the second set, wherein the dividers separate pairs of pixels.

8. The display device of claim 7, wherein each divider is associated with a single prism of the prismatic array.

9. The display device of claim 8, wherein the pixel array is spaced apart from the prismatic array.

10. The display device of claim 9, wherein each divider is disposed in the space between the pixel array and the prismatic array.

11. The display device of claim 1, wherein the first and second sets of pixels include reflective pixels.

12. The display device of claim 11, wherein the reflective pixels include one or more interferometric modulators.

13. The display device of claim 1, wherein the pixel array constitutes a display, the display device further comprising:
a processor that is configured to communicate with the display, the processor being configured to process image data; and
a memory device that is configured to communicate with the processor.

14. The display device of claim 13, further comprising a driver circuit configured to send at least one signal to the display.

15. The display device of claim 14, further comprising a controller configured to send at least a portion of the image data to the driver circuit.

16. The display device of claim 13, further comprising an image source module configured to send the image data to the processor.

17. The display device of claim 16, wherein the image source module includes at least one of a receiver, transceiver, and transmitter.

18. The display device of claim 13, further comprising an input device configured to receive input data and to communicate the input data to the processor.

19. A method for manufacturing a display device, the method comprising:
providing a pixel array, the pixel array including a first set of pixels configured to display image data for a right eye of a viewer and a second set of pixels configured to display image data for a left eye of a viewer, wherein the pixels of the first set are interspersed amongst the pixels of the second set; and
providing a plurality of prisms coupled to the pixel array, with each prism aligned with a pixel from the first set of pixels and a pixel from the second set of pixels, each prism having a first facet and a second facet,
wherein the first facet is configured to be substantially parallel to a line of sight converging towards a region corresponding to a position of the right eye, and wherein the second facet is configured to be substantially parallel to a line of sight converging towards a region corresponding to a position of the left eye.

20. The method of claim 19, wherein providing the plurality of prisms includes attaching the plurality of prisms to the pixel array.

21. The method of claim 19, wherein the plurality of prisms is configured to substantially converge light rays from pixels of the first set of pixels towards the region corresponding to the position of the right eye, and to substantially converge light rays from pixels of the second set of pixels towards the region corresponding to the position of the left eye.

22. The method of claim 19, further comprising attaching dividers to the plurality of prisms, each of the dividers extending between facets of neighboring prisms.

23. The method of claim 22, wherein the dividers are configured to substantially prevent light rays containing image data for the right eye from converging on the left eye and is configured to substantially prevent light rays containing image data for the left eye from converging on the right eye.

24. The method of claim 19, the pixel array including multiple pairs of pixels, each pair including a pixel from the first set and a pixel from the second set, the method further comprising mounting dividers between each pair of pixels in a space between the pixel array and the plurality of prisms.

25. The method of claim 19, wherein providing the pixel array includes forming a plurality of interferometric modulators as pixels.

26. A display device comprising:
a pixel array, the pixel array including a first set of pixels configured to display image data for a right eye of a viewer and a second set of pixels configured to display image data for a left eye of the viewer, wherein the pixels of the first set are interspersed amongst the pixels of the second set; and
means for converging light by refraction, wherein the light converging means is configured to refract light rays from pixels of the first set so that the light rays substantially converge towards a region corresponding to a position of the right eye, and to refract light rays from pixels of the second set so that the light rays substantially converge towards a region corresponding to a position of the left eye.

27. The display device of claim 26, wherein the region corresponding to the position of the left eye is a point corresponding to the position of the left eye, and wherein the region corresponding to the position of the right eye is a point corresponding to the position of the right eye.

28. The display device of claim 26, further comprising dividing means positioned between pixels of the first set and pixels of the second set, wherein the dividing means is configured to substantially prevent light rays containing image data for the right eye from converging on the left eye and is configured to substantially prevent light rays containing image data for the left eye from converging on the right eye.

29. The display device of claim 28, wherein the pixels are grouped in pairs, each pair including a pixel of the first set and a pixel of the second set, wherein the dividing means separate pairs of pixels.

30. The display device of claim 28, wherein the dividing means includes an opaque layer coating facets of the light converging means.

31. The display device of claim 29, wherein the dividing means includes a plurality of dividers, each divider associated with a single prism of the prismatic array.

32. The display device of claim 31, wherein the pixel array is spaced apart from the light converging means.

33. The display device of claim 32, wherein each divider is disposed in the space between the pixel array and the light converging means.

34. The display device of claim 26, wherein each pixel in the pixel array includes one or more interferometric modulators.

35. The display device of claim 26, wherein the light converging means includes a plurality of prisms.
